(19) United States
(12) Patent Application Publication
(10) Pub. No.: US 2003/0074234 A1
(43) Pub. Date: Apr. 17, 2003

(54) Customer-centered pharmaceutical product and information distribution system

(76) Inventor: Jeanne Ann Stasny, Saukville, WI (US)

Correspondence Address: MICHAEL BEST & FRIEDRICH, LLP, 100 E WISCONSIN AVENUE, MILWAUKEE, WI, 53202, US

(21) Appl. No.: 10/049,180

(22) PCT Filed: Jun. 14, 2001
(86) PCT No.: PCT/US01/19034

(51) Int. Cl. G06F 17/60

(52) U.S. Cl. 705/4

(57) ABSTRACT

A customer-centered pharmaceutical product and information distribution system. The system includes a customer terminal (52) and a pharmacy terminal (56), both terminals coupled to a network. The pharmacy terminal is coupled to a pharmacy management system that has a database. A third terminal is also connected to the network. The third terminal is selected from the group consisting of an insurance provider terminal (62), a fiscally responsible party terminal (82), a physician terminal (54), a government agency terminal (80), a drug manufacturer terminal (60), and a flexible benefits operator terminal (58). A server (74) is also coupled to the network. The server has a site (72) accessible by the customer, the pharmacy, and the third terminal. The server also has a database that is synchronized with the database of the pharmacy management system.

### BACKGROUND OF THE INVENTION

The present invention relates to methods and systems for providing information, products, and services to a prescription drug customer, and more specifically, to methods and systems for increasing the customer's involvement and influence in pharmaceutical decisions.

FIG. 1 schematically illustrates the current relationships between parties associated with distributing prescription drugs from drug manufacturers to prescription drug customers. The process starts when a patient or customer 30 visits a physician 32. The physician makes a diagnosis and prescribes a prescription drug. The customer then brings the prescription to a pharmacy 34 to obtain the prescribed drug.

Staff at the pharmacy 34 enters the customer's personal information into the pharmacy's computer system (often referred to as a “fill and bill system”). If the prescription drug customer has previously used the pharmacy, the information is generally already in the pharmacy's computer system and only needs to be confirmed and/or updated by the pharmacist. The fill and bill system may also list any other medications currently being used by and allergies or other medical conditions of the customer. If this information is not available, the pharmacist will solicit such information from the customer prior to filling the prescription.

Often times the physician 32 prescribes a class of drug, or several brands of drugs, without specifying a particular prescription drug. When this occurs, the pharmacist discusses the options with the customer. There may be one or more brand name drugs and one or more generic equivalents available to the customer. The customer and the pharmacist decide which drug the customer will use. This decision is often based on the pharmacist's recommendation and/or the coverage the health insurance of the customer. Many health insurance providers favor the use of less expensive generic drugs and often deny coverage for brand name drugs when a generic equivalent is available. In addition, insurance providers may have a lower customer co-pay amount for generic drugs. In general, the only way the pharmacist can determine the coverage provided by the customer's health insurance is by calling the insurance provider at the time of filling a prescription.

When a pharmacist recommends a prescription drug, he confirms that the newly prescribed drug is safe for use by the customer (i.e., the drug will not dangerously interact with other medications currently being used by the customer, the customer has no allergies to the drug, the customer has no medical conditions preventing the use of the drug, etc.). Assuming there are no reasons why the chosen drug cannot be used, the pharmacist enters the prescription into the fill and bill system. The pharmacist fills the prescription from his bulk supply of the drug, which is typically purchased from a distributor that deals directly with the pharmaceutical manufacturer. The pharmacist packages the prescribed amount of the drug for the customer and labels the package with a label printed by the fill and bill system. The label typically includes the customer's name and physician's name, the name of the prescription drug, dosage and use instructions, the number of refills available, and the expiration date of those refills.

The pharmacy 34 typically has some method of inventorying the drug supply to monitor how much of the drug is currently available and when more should be ordered from the distributor. Some fill and bill systems include an automated inventory function that is updated when the pharmacist enters prescriptions.

Prior to receiving the filled prescription, the customer either pays for the drug himself or, more often, provides the pharmacist with his or her insurance information. When the customer provides the insurance information, the pharmacist determines how much, if anything, the customer must pay for the prescription drug. Calculation of the customer's co-payment may also be done by the fill and bill system. The customer tenders any money he may owe for the prescription drug. An insurance claim for the prescription is also prepared by the pharmacist or fill and bill system.

The pharmacist is required by federal regulations to offer the customer a consultation prior to delivering the prescription drug. In the consultation, the pharmacist explains the manner of using the drug, potential side effects, the number of refills available, and asks the customer if he or she has questions or concerns. The consultation may involve and exchange of includes information provided by the physician, the pharmacist, and the manufacturer of the drug. The pharmacist may also provide a printed information describing the drug and its use. After the consultation is complete, the pharmacist gives the filled prescription to the customer.

In most cases, the pharmacy gets paid (with the exception of any co-pay amount tendered by the customer) by the health insurance provider 36 after the claim is processed. Typically, the customer will not hear from either the pharmacy or the insurance provider once the prescription is filled. If the insurance provider denies the claim, the pharmacy or the insurance company bills the customer directly. At this point, the customer needs to determine why the claim was denied. To do so, the customer must contact a representative of the insurance company. Until the situation is resolved, the pharmacy or insurance provider will continue to bill the customer.

### SUMMARY OF THE INVENTION

The inventor(s) has (have) recognized a need for an improved system of distributing pharmaceuticals and communicating information between customers, pharmacists and pharmacies, drug manufacturers, insurance companies, and other entities involved in the distribution of prescription drugs.

One shortcoming associated with the system shown in FIG. 1 relates to the limited access customers have to drug manufacturers 38 and the wide variety of products they offer. Even with the advent of pharmaceutical advertisements and web sites, patients currently receive most pharmaceutical information from physicians or pharmacists. Patients rely on these individuals to keep abreast of the latest developments in the industry, which is not an easy task. The number of different types and brands of prescription drugs is already very large and continues to grow. Time limitations placed upon the physicians and pharmacists often lead to a lack of knowledge of the treatments and drugs available. Often, a physicians'recommendation is be based simply on the fact that a drug manufacture effectively marketed its drug directly to that physician, even though a more cost effective or medically effective drug is available to the patient.

Another problem recognized by the inventor(s) relates to communication among and between other parties involved in the prescription drug process. A number of government agencies 40 (e.g., the FDA, FTC, HHS, and others) regulate the manufacture of drugs, the provision of healthcare benefits by employers for employees, and activities of technology support companies 42 that provide communication links and technical support to the actors in the system current with these agencies is critical, but less than satisfactory in the current drug distribution system because information is often duplicated and decentralized.

Communication is also deficient when insurance claims for prescriptions are denied. One cause for denial involves the prescription of non-covered drugs. Currently, there is no quick and easy way prior to filling the prescription to cross-reference the available options with the customer's insurance plan to determine if there is a drug that could be used to treat the customer that is also covered by the customer's insurance. If a claim is denied, the customer is only informed at the time the prescription is filled or at a later date when the treatment has already begun. The customer is then left to sort out the denial, attempt to find a treatment that is covered by insurance, or pay for the drugs out-of-pocket.

The communication flaws described above equate to less information available to the customer and a relatively burdensome system associated with obtaining and paying for the best available treatment. Ultimately, the current system does not achieve the goal of maintaining the health of the customer in an efficient and effective manner.

Yet another problem of the current system relates to the influence insurance companies have over the drugs patients take. Most customers have no choice or limited choices in picking an insurance provider. Employers 44 determine what type of coverage they will provide to their employees. In some cases, larger employers act as self-insurers. The insurance companies (or employers) then determine which prescription drugs and treatments they will cover. Thus, with little or no say in the matter, the customer may have no coverage for drugs that may be suitable for his or her need. While private insurance or cash payment is possible, most customers lack the financial resources to finance these options.

Perhaps the biggest deficiency in the current system is that the customer is a passive participant in the pharmaceutical decisions affecting his or her health. The customer has little knowledge of all available treatments, and must rely on their physician's recommendation of a treatment and prescription drug. As noted, the physician's recommended treatment may not be the most effective one available. Additionally, the customer does not usually know what type of insurance coverage they have for specific brands of drugs and, therefore, may end up paying for uncovered brand name drugs that could be replaced with a covered generic equivalent.

The token involvement and influence of the customer is due in large part to the lack of interaction between the customer and the other parties in the system. The current system isolates the parties from one another. For example, while drug manufacturers 38 can communicate with the pharmacies 34 via technology support companies 42, the manufacturers are not permitted to see which customers are, or could be, using their drugs. Only the customer 30, the physician 32, and the pharmacist are privy to such information. The manufacturer, therefore, relies on the physician or pharmacist to present the manufacturer's available and up-and-coming treatments to the customer.

While there may be reasons (e.g., privacy) for prohibiting manufacturers from obtaining customer information, there are disadvantages to prohibiting interaction between the customer and the manufacturers. If the pharmacist or physician is not aware of a particular treatment, the customer may not be fully informed of the options and may not obtain the best treatment available for a particular condition. Since the manufacturers have no access to the customer's medical profile, they cannot aid in presenting all available options to the customer. If the drug manufacturer could contact the customer directly, he or she might learn of options suitable to his or her circumstances.

Another deficiency of the current system is an inability to track customer compliance. As used herein, “compliance” refers to a measurement of whether the customer takes the prescribed drugs according to the physician's instructions. Compliance can be monitored by comparing the date the customer obtains a refill against the date the refill should have been obtained if the drug was taken as directed. Compliance is a major issue having an impact on all of the parties in the system. A compliant customer has the best chance of becoming healthy in the shortest amount of time. Healthy customers are positive indicators of the efficacy of the manufacturer's drug and reduce overall health costs, which are, of course, of interest to insurance providers, employers, and patients.

The methods and systems of the present invention alleviate these and other problems. The invention includes a pharmaceutical system having a communication and information network that is centered around the customer and that is accessible to all of the other parties involved. In one embodiment, the invention provides a customer-centered pharmaceutical product and information distribution system. The system includes a customer terminal coupled to a network and a pharmacy terminal coupled to the network The pharmacy terminal is coupled to a pharmacy management system that has a database. A third terminal is also connected to the network. The third terminal is selected from the group consisting of an insurance provider terminal, a fiscally responsible party terminal, a physician terminal, a government agency terminal, a drug manufacturer terminal, and a flexible benefits operator terminal.

A server is coupled to the network. The server has a site accessible by the customer, the pharmacy, and the third terminal. The server also has a database that is synchronized with the database of the pharmacy management system. Preferably, the insurance provider terminal is coupled to an insurance store having information regarding insurance coverage.

In another embodiment, the invention provides a method of networking a customer with parties involved in providing information and services that can increase the customer's involvement and influence in making personalized pharmaceutical decisions. The method includes providing customer/pharmacy data on a network, providing customer/insurance company data on the network, providing customer/pharmaceutical manufacturer data on the network, and granting access to the network to a customer, a pharmacist, an insurance company, and a pharmaceutical manufacturer.

These features as well as other advantages of the invention will become apparent upon consideration of the following detailed description and accompanying drawings of the embodiments of the invention described below.

### BRIEF DESCRIPTION OF THE DRAWINGS

FIG. 1 is a schematic diagram of a prior-art system of providing information and services to a prescription drug customer.

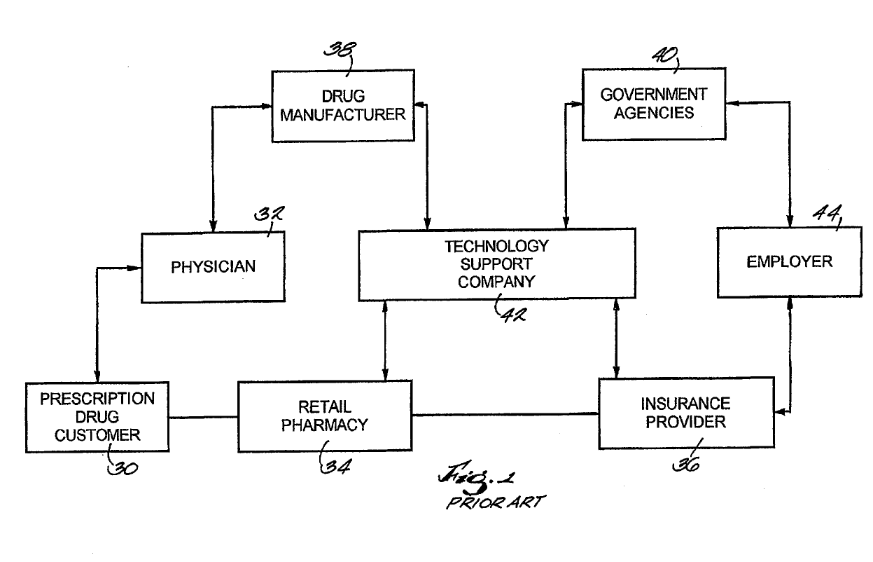

FIG. 2 is a schematic diagram of an embodiment of the invention.

FIG. 3 is a schematic diagram of a customer-centered pharmaceutical system according to one embodiment of the invention.

FIG. 4 is another schematic diagram of the pharmaceutical system illustrated in FIG. 3.

FIG. 5 is a schematic diagram of the pharmacy terminal illustrated in FIG. 3.

FIG. 6 is a schematic diagram of some of the functions a customer can perform utilizing a web site of one embodiment of the invention.

FIG. 7 is a schematic diagram of how a customer accesses the web site of the invention.

FIG. 8 is a schematic diagram of how a customer maintains an account.

FIG. 9 is a schematic diagram of how the customer orders refills.

FIG. 10 is a schematic diagram of how a customer checks refill status.

FIG. 11 is a schematic diagram of how a customer requests information and views responses.

FIG. 12 is a schematic diagram of how a customer views profile information.

FIG. 13 is a schematic diagram of how a customer requests or orders recommended products.

FIG. 14 is a schematic diagram of some of the functions the pharmacist can perform utilizing an embodiment of the invention.

FIG. 15 is a schematic diagram of the flow of information between a database server and a database.

FIG. 16 is a schematic diagram of some of the functions an administrator can perform utilizing an administration module.

FIG. 17 is a schematic diagram of creation of an educational page for an educational module.

FIG. 18 is a diagram of a data flow model for an embodiment of the invention.

### DETAILED DESCRIPTION

Before embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

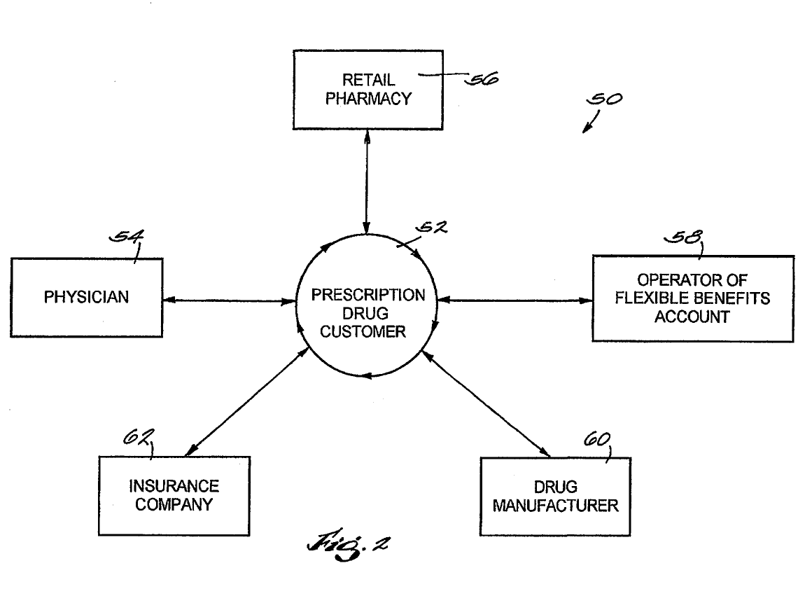

FIG. 2 schematically illustrates an embodiment 50 of the invention. It should be noted that FIG. 2 is only representative of one embodiment of the invention. As such, other embodiments that include fewer or more parties are also encompassed by the invention. In the embodiment 50, a prescription drug customer 52 is positioned at the center of a group of parties participating in the distribution of pharmaceuticals and the exchange of pharmaceutical and other information. The two-way arrows represent the two-way communication and information transfer between the customer and the remaining parties: a physician 54, retail pharmacy 56, an operator 58 of a benefits account, a drug manufacturer 60, and an insurance provider 62. Each party can exchange data with the others, but what provides significant benefit is that the customer has two-way data exchange with the physician 54, pharmacy 56, benefits account operator 58, and drug manufacturer 60. As used herein, the term “data” can include any communication, data, contact, or other transfer of knowledge or information pertaining to the relationship of the two or more parties specified.

The data available to the customer 52 can be selectively shared and used by all of the parties as desired. This selective sharing of data between parties is represented by the circular arrow configuration around the customer. The networking systems and methods of the invention ultimately provide the customer with access to each of the parties, and in turn, provide each of the parties with at least limited access to the customer and the customer's information. As such, the network becomes personalized and extremely useful to the customer for making pharmaceutical decisions.

For example, educational data and data regarding rebates or incentives on various prescriptions, brand-to-brand comparisons, available alternative treatments, and the scope of insurance coverage can be used by the customer. The other parties involved also benefit from the exchange of information. For example, pharmacists and physicians get valuable input from the manufacturers on available treatments that might be suitable for a specific customer. Additionally, the pharmacist can minimize the number of denied claims by quickly checking whether the customer's insurance provider covers the prescribed treatment before filling the prescription. The pharmacy, the insurance provider, the manufacturer, and the physician can all monitor prescription drug customer compliance and take steps to help the prescription drug customer comply.

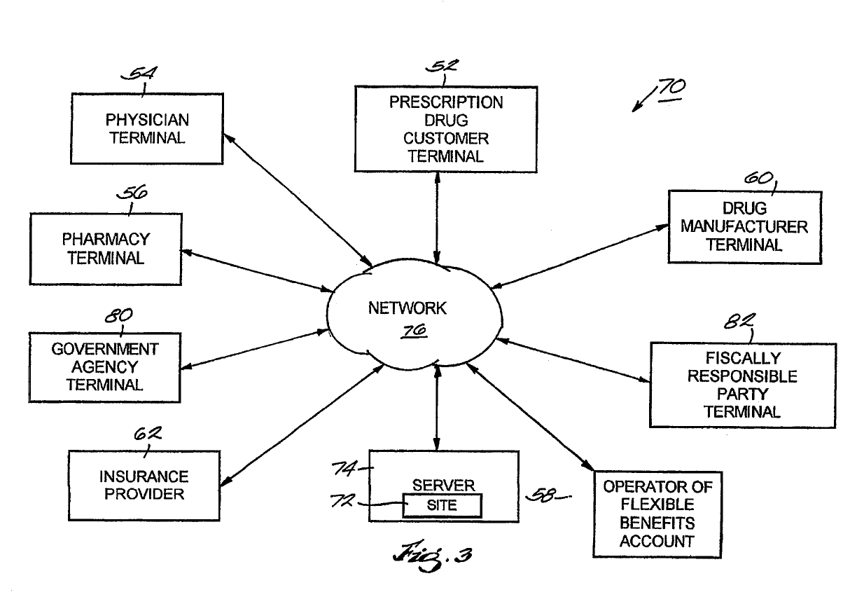

In one embodiment, the invention is a network-based system, such as the system 70 shown in FIG. 3. A site 72 (such as an Internet site) is created on a server 74 as the prescription drug customer's gateway to obtaining information from pharmacists, drug manufacturers, government agencies, fiscally responsible parties (e.g., employer who pays insurance premiums or fund private insurance), physicians, and any other parties that may have access to a network 76. In the example shown, the physician 54, pharmacy 56, benefits account operator 58, drug manufacture 60, and insurance company 62 are shown coupled to the network 76. Also connected to the network 76 are a government agency 80 and a fiscally responsible party 82.

It should be understood that while the description discusses parties being “connected” to the network 76, the parties are not part of the physical layer of the system. Rather, the parties operate computers, terminals, or other hardware devices that are connected to the network 76. The terminals may include standard input and output devices such as a mouse, keyboard, printer, and display. Of course, the terminals could include a host of advanced and/or yet to be developed input and output devices such as voice recognition devices. The terminals or hardware devices may include an operating system, a browser, and communication software for communicating with the server 74 and each of the other terminals via the network 76. Preferably, the browser is a web based browser, such as a Microsoft Explorer browser or a Netscape Communicator browser, capable of displaying information formatted with a fixed set of tags, such as HTML or XML documents. In a preferred embodiment, the network 76 is the Internet, thereby providing global communication and scale to the invention. However, the network may be other types of networks, whether packet switching or not or based on Internet protocols or not. Further, although not shown, the system 70 can be scaled to include numerous customer's, physicians, pharmacies, insurance providers, and other parties, and, of course, associated terminals.

In one embodiment, the site 72 can include web pages for each participating pharmacy 56, with each drug customer 52 having his own secure account for interaction with the web site and a pharmacy specific web page. The customer is provided with a login name and password. Once logged onto the site, the customer can input his personal information, including his medical profile. Alternatively, his information can be loaded automatically by the fill and bill system or pharmacy management system of the pharmacy when the prescription drug customer's account is set up. Preferably, the pharmacy management system communicates with the server 74 such that the customer's personal account may be kept up to date.

Once the customer's personal account is operational, any of the other parties can be granted access to the account. This may require the customer 52 to waive certain privacy rights. As the system evolves, other parties that are not mentioned or described herein can also be added to the network. Other pages and links can be provided to organize the personal and customized information available to the customer.

The customer can access personalized information relating to any of the networked parties. This includes, for example, information provided by the drug manufacturer 60 about prescription drugs the customer is currently using or drugs that might be suitable for the customer. The information can be tailored specifically for the customer based on the medical profile in the customer's personalized account. Dangerous interactions, drug allergies, and other risks can be communicated to the customer. Since the physician 54 and the pharmacist can also access the customer's account, they can consider the manufacturer's recommendations and decide whether the treatment recommended by the manufacturer is a viable option for the customer. While the manufacturer does not make any final decisions about the customer's treatment, the physician and pharmacist may be provided with more options from which to choose.

The system 70 also provides the customer access to information from his fiscally responsible party regarding claim status for filled prescriptions, available coverage, and price information for various drugs and treatments, and any other beneficial information. This information allows the customer to make an informed decision as to which treatment options are affordable and which are not. It also makes communication easier and reduces the number of misunderstandings leading to coverage disputes.

The customer 52 can also view his records on the site 72 (as provided or updated from the pharmacy management system), including usage instructions for the prescriptions, refill status, and any other beneficial information. The customer can communicate with the pharmacist to request refills and ask questions regarding dosage, usage, and side effects. Responses can be posted on the site or e-mailed directly to the customer. This portion of the web site can also include refill renewal forms that can be faxed, e-mailed, or sent over the network to the physician 54.

Drug manufacturers send information to the server 74. The information may include data about drugs and treatments the manufactures produce, conditions and/or allergies the drugs and treatments can be prescribed for, side effects the drugs and treatments may cause, interactions that may occur when the drugs and treatments are used with other drugs and treatments, educational content for the drugs and treatments, pricing, and discounts or special deals that are currently available. After receiving the information, the server 74 updates other computer and software components (discussed below) to ensure that updated information is used by the parties participating in the system 70. An advantage of the invention is that the pharmaceutical system 70 may be configured to allow drug manufacturers to provide information about specific drugs to a particular segment of customers. For example, if the drug manufacture has just released a new drug that effectively treats high blood pressure, it would be advantageous for the drug manufacture to target all customers that have high blood pressure listed as a condition in their profile. In an alternative embodiment, the drug manufacturer can offer a discounted rate to a customer that previously used one of their drugs, but has since switched to a substitute drug. If the drug manufacturers have access to more information about the customers they will be better able to assist in the recommendation of drugs and treatments that the physician or pharmacist may not be aware of. The drug manufacturer can inform the customer of such alternatives and the physician and pharmacist can directly view the customer's profile to evaluate the suggestions, or the customer can interact communicate with the physician or pharmacist regarding the suggestions.

The fiscally responsible party (e.g., an employer, etc.) also provides information to the system 70. This information may include drugs and treatments covered and any co-payments required by the customer. Interaction between the fiscally responsible party and the drug manufacturers may change the coverage provided to the customer if a more expensive drug is demonstrated to be more effective in treating a condition or allergy in a shorter amount of time. Fiscally responsible parties do cost benefit analyses of the drugs and treatments they cover and determine from that what type of coverage to extend to the customer. The information about coverage is communicated from the server 74 to the pharmacy. The information allows the pharmacist to determine what drug or treatment is most cost effective for the customer. The fiscally responsible party may also interact with the government agency regarding what types of coverage they are required or not required to offer to the customer. If a dispute arises regarding coverage for a particular drug, the pharmaceutical system 70 provides a quick and efficient avenue for communication and resolution of the problem.

Government agencies provide information on rules and regulations they have established with respect to distributing pharmaceutical drugs and providing coverage to the customer. An agency may also utilize the pharmaceutical system 70 as a forum for discussion of possible changes in the rules and regulation. The government agency may also receive complaints from customers about parties that are participating in the pharmaceutical system 70 that are not abiding by the established rules and regulations.

Physicians use the system 70 to respond to requests for prescription renewals, answer questions regarding proposed drugs and treatments for a customer, and view information provided by the drug manufacturers about new and existing drugs and treatments. The physician can view the customer's profile to determine the compliance of the customer with respect to a particular drug. If the customer is not following the established regimen, the physician can use this information when discussing conditions and treatments with the customer.

Having described the general architecture and operation of the system 70, its various components will now be described in greater detail.

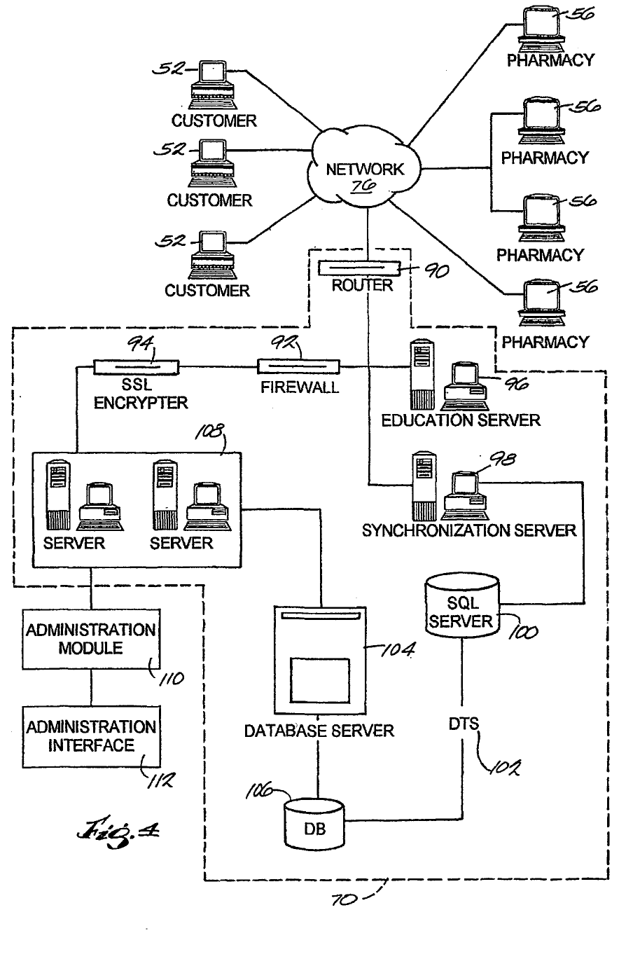

FIG. 4 illustrates components of the system 70 in more detail. For purposes of discussion, the system 70 is illustrated with customers and pharmacies only. As shown in FIG. 4, the system 70, includes a router 90, a firewall 92, an encryption module 94, an educational content server 96, a synchronization server 98, a SQL server 100, a data transformation service 102, a database server 104, a database 106, and a pharmaceutical system software server 108.

The router 90 is capable of interconnecting the terminals and the servers 108, 90, and 98. In one embodiment, the router 90 interconnects two or more computer networks that use a single network layer procedure, but that may use different data link layer and physical layer procedures. The firewall 92 can be any of a number of hardware/software components that prevent unauthorized users from gaining access to the servers, or that monitor transfers of information to and from the network 76. In one embodiment, the firewall 92 is a software module such as the Check Point Firewall-1 that further requires a dedicated computer system. In another embodiment, the firewall 92 is a hardware module such as the Cisco PIX 515. The encryption module 94 is capable of encrypting information passed between the terminals and the servers via the network 76. An appropriate security solution is necessary in order to protect personal information of the customer that is transferred over the network 76. In one embodiment, the encryption module 94 is an Intel SSL Encrypter.

The educational content server 96 includes educational modules that the customer can access. The educational modules may include information on how to properly administer prescribed drugs or treatments, or alternatives to the prescribed drugs or treatments. The pharmacist can recommend to the customer that he view media clips, listen to audio clips, or read text in the educational modules that may help him to better understand how to use the drugs and treatments that he is being provided. The actual educational content or information can be built as web pages that include links to pages within the educational modules. The educational modules may also include quizzes that test the customer's understanding of the educational content. In one embodiment, the educational content server 96 uses Windows NT Enterprise Server 4.0 software.

The synchronization server 98 is responsible for ensuring that the database 106 of the server 104 includes up-to-date data, (i.e., the same data that is provided by the parties at each terminal connected to the system). Each terminal can contact the synchronization server 98 and download and/or upload any changes to the information stored in the database server 104. In one embodiment, the synchronization server 98 uses Windows NT Enterprise Server 4.0 software.

The SQL (Structured Query Language) server 100 handles queries and loads of the database 106. In one embodiment, the SQL server 100 includes SQL Server 7.0 Enterprise Internet Connector software. The data transformation service 102 modifies the data being transferred to the database 106 when the physical representation of the data used in the source hardware or software environment is not compatible with the hardware or software environment of the database 106. Similarly, the data transformation service 102 also modifies data transferred from the database 106 if it does not have the correct physical presentation for destination hardware or software.

The database server 104 and associated database 106 store information including information about the customers. This information may be accessed by the terminals if appropriate authorization is given to the requesting terminal to upload and/or download such information. In one embodiment, the database server 104 is an HP Unix database server and the database 106 is built using Oracle 8i Enterprise Edition server software.

The pharmaceutical system software server 108 contains software that is accessed by customers. In a preferred embodiment, the pharmaceutical system software server 108 includes web pages that are accessed by the customer. The pharmaceutical system software server 108 may also include content and software that is accessed by the other terminals in the system. In one embodiment, the pharmaceutical system software server 108 is a cluster of Windows NT web servers

Preferably, the server 74 has the capability to handle tens of thousands of pharmacy terminals sending updates to the server at regular intervals. (An average pharmacy handles approximately 200 transactions per day and updated information regarding each transaction needs to be sent to the server.) Additionally, it is preferable that the server 74 handle over 200 simultaneous connections and have a constant uptime for operation (i.e., 24 hours a day, 7 days a week). It is also preferable that web pages provided by the pharmaceutical system software server 108 load quickly when interfaced by the customer (i.e., within 5-10 seconds for content pages and 10-15 seconds for dynamic pages over a standard dial-up connection). The database server 104 needs to have a memory storage capacity to store information from each of the terminals, conservatively estimated to be between 45 gigabytes and 195 gigabytes.

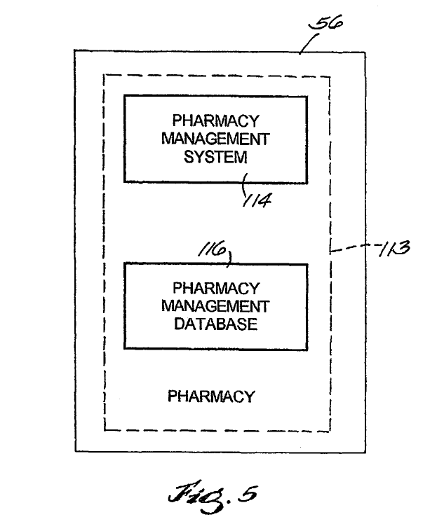

The server 74 is administered by a system administrator using an administration module 110 having an administration interface 62. As will be discussed in greater detail below, the administrator performs setup and ongoing maintenance of the server 74. As should be apparent the discussion herein, the server 74 plays an important role in the system 70. However, computer systems at each of the participating parties are also important. FIG. 5 illustrates a computer system 113 at an exemplary pharmacy 56. The computer system 113 includes a pharmacy management system 114. The pharmacy management system 114 is coupled to a data base 116 that stores information including customer address, phone number, physician, insurance provider information as well as a list of any medications currently being used by the customer and any known allergies or other medical conditions that the customer has. The pharmacy management system 114 is a type of a fill and bill system and has the ability to interface all new and changed customer accounts, customer prescriptions, responses to customer requests, profile information, changes to the pharmacists, changes to web site content, etc. In a preferred embodiment, the pharmacy management system 114 is designed to effectively interact with the server 74 and the other components of the system 70. Alternatively, upgrades may be provided to allow existing pharmacy management software to interact with the system 70.

In operation, the pharmacy at which the customer is a patron registers with the server 74. The pharmacy contacts the administrator and an account is established. The pharmacy assists the administrator in developing a pharmacy specific web page that is accessible by customers. The web page may also be accessible from the pharmacy's own standalone web site. The pharmacy specific web page includes contact and operating information about the pharmacy and other pharmaceutical content. The pharmacy is equipped with the pharmacy management system 114 or an upgrade to its existing management software to provide functionality equivalent to that provided by the computer system 113.

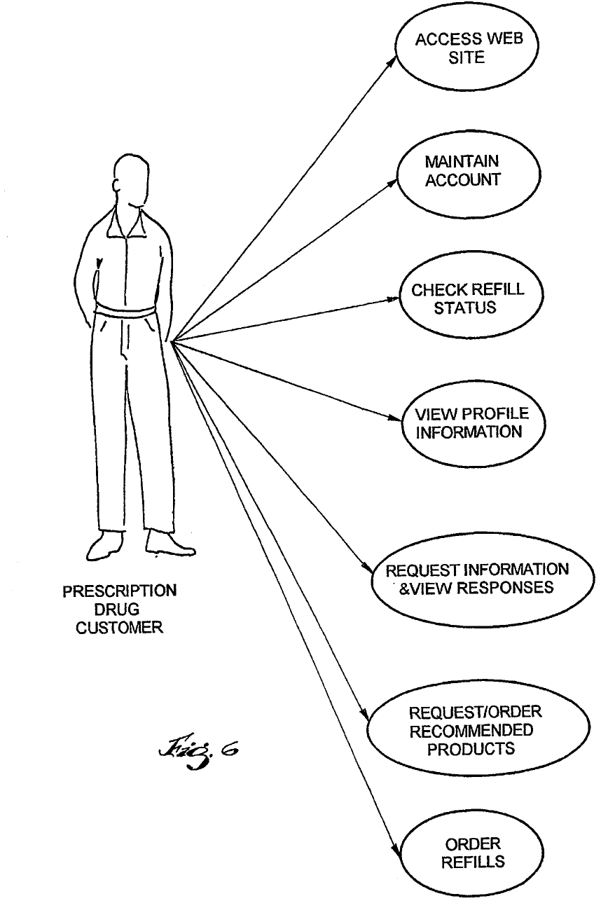

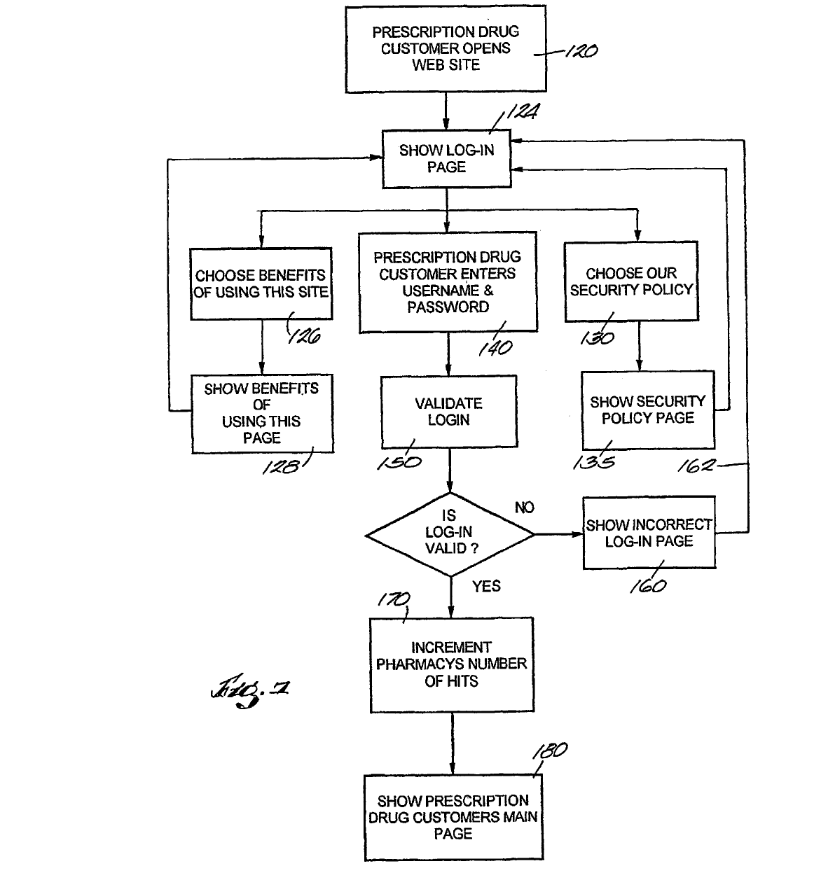

After the pharmacy is setup for participation in the pharmaceutical system 70, customers of the pharmacy register for participation in the system. As noted, each customer receives a username and a password for logging onto the web site and establishes a profile. FIG. 6 schematically illustrates some of the functions the customer can perform utilizing the web site 72. The customer can maintain their account, request/order recommended products, order refills, check refill status, view profile information, and request information and view responses. FIG. 7 illustrates these processes in more detail. As shown at step 120, Customer Opens Web Site, the customer opens the web site by connecting to the network 76 using a browser. Next, as shown at step 124, Show Login Page, the login page of the web site is displayed. The customer can then choose to enter user specific content of the web site or to view general non-user content of the web site.

The customer is presented an option 126 to view content 128 regarding the benefits of using the system 70. The customer is also presented an option 130 to view the security/privacy policy 135 for the system 70. The general content of the web site can include as much or as little information about prescription drugs and treatments and the pharmaceutical system 70 as the administrator desires to provide the general public.

If the customer has registered with the system 70, he or she may enter his or her username and password, as shown at step 140. The username and password information is then validated at step 150. If the login is not valid, a web page is loaded that informs the customer that the data fields are invalid, as shown at step 160. The customer is then redirected to re-enter username and password information, as shown by path 162.

If the username and password is valid then a hit counter is incremented at step 170. After the counter is incremented, the customer's main page is loaded, as shown at step 180. Based on the customer's age and medical conditions that are stored in the profile, an appropriate interface is established (e.g., older customers are provided with larger lettering that is easier for them to read). This may include viewing a pharmacy specific web page that has an age appropriate font and background depending on what demographic the customer falls into (i.e., geriatric, adult, or child/young adult). Step 180 may also include providing a customer interface in different languages, such as French, English, Spanish, etc., depending on the language spoken by the customer.

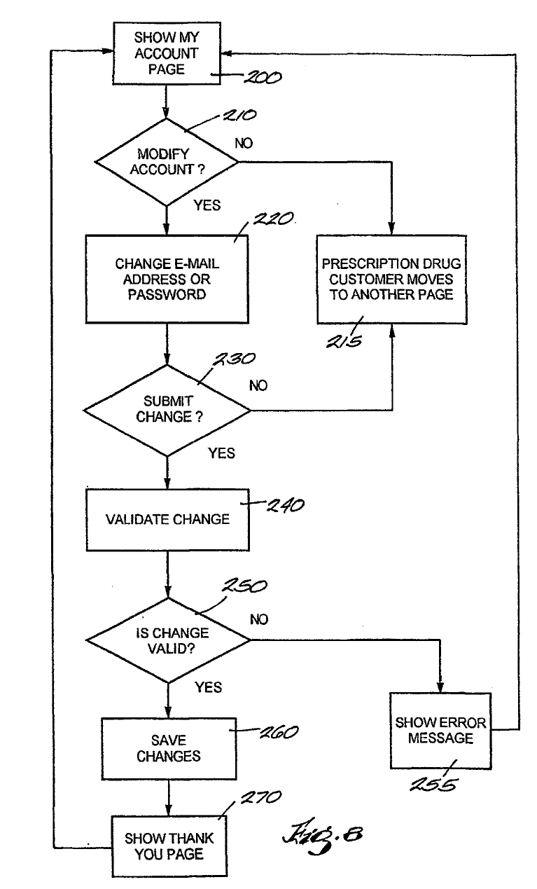

FIG. 8 schematically illustrates how the customer maintains their account using the web site 72 of the pharmaceutical system 70. As shown at step 200, Show My Account Page, the customer can view various content and select several options. A page is loaded that shows the account information and, as shown at step 210, Modify Account?, the customer is asked if they would like to modify any of the information currently listed in the account profile. If the customer does not wish to modify their account, the customer may move to another page, as shown at step 215, Customer Moves to Another Page. In a preferred embodiment, the web site reloads the main page. If the customer does wish to modify their account, they may make various changes, as shown at step 220. Examples of information that the customer can change include the email address they use to receive information from the pharmaceutical system 70 and the password used to access the web site.

If the customer enters a proposed change to their account, as shown at step 230, Submit Change?, they are asked if they would like to submit the change. If the customer does not wish to submit the change, the customer may move to other portions of the site, as shown at 215. If the customer does submit the change, the validity of the change is checked, as shown at step 240, Validate Change. If the proposed change is invalid, an error message is generated, as shown at step 255, Show Error Message. After the error message is displayed, the customer may be redirected to step 200. If the proposed change is valid, the proposed change is saved at step 260, Save Changes, and the customer is informed that the change was successful at step 270, Show Thank You Page. Once the customer has completed viewing the confirmation page, the customer is redirected to step 200.

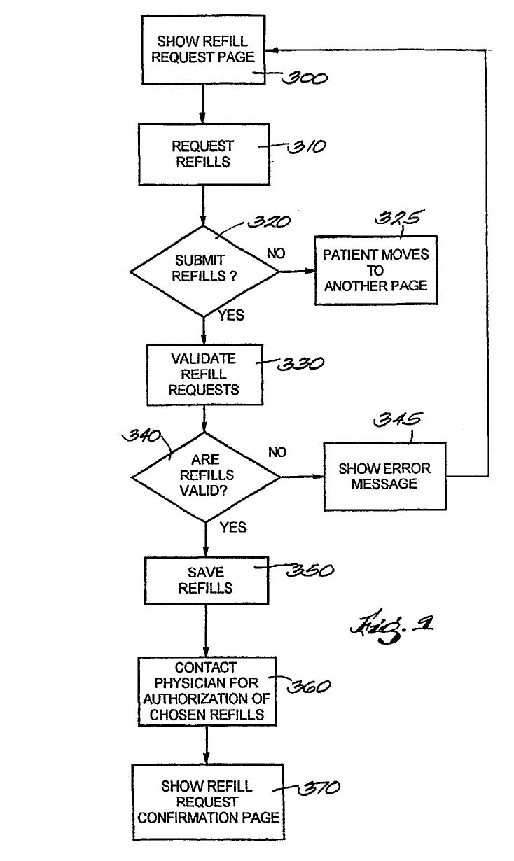

FIG. 9 schematically illustrates how the customer orders refills using the pharmaceutical system 70. As shown at step 300, Show Refill Request Page, the customer can select a refill request page. In one embodiment, only the prescriptions that are less than one year old are shown on the refill request page. The customer may be able to load the prescriptions that are older than one year old, but ideally the customer should have checkups with his or her physician where older prescriptions are evaluated and adjusted according to the progress of the prescribed regimen. As shown at step 310, Request Refills, the customer is allowed to select any of the prescriptions that are currently stored in the pharmaceutical system 70, and request a refill. The customer enters a proposed date to pickup the refill from the pharmacy. If a prescription has expired (either by date or by number of refills) and the customer would like to continue receiving the prescription drug, the customer's physician is contacted for authorization. The physician can be contacted using fax, phone, or by contacting the representative computer system at the physician's office. If the customer would like an expired prescription renewed, this fact is indicated on the refill request. Once the customer has selected the prescriptions they would like refilled and entered information in all of the required fields, a determination is made whether or not the request is valid, as shown at step 340. If the request is not valid, an error message is displayed, as shown at step 345. An example of an invalid request is a pickup date that is past a future expiration date of the selected prescription After the error message is displayed, the customer is redirected to step 300.

If the request is valid, the request is saved in the database server 104 at step 350, Save Refills. At step 360, Contact Physician For Authorization of Chosen Refills, the customer's physician is contacted for authorization to continue the expired prescription. At step 370, Show Refill Request Confirmation Page, a web page is loaded that shows the customer what refills are refillable and on what date they will be ready for pickup, and what refills are waiting for approval from the physician.

Once the customer has finished reviewing the show refill request confirmation page, the customer can return to the main page for further action by the customer. All information regarding refills requested is sent to the respective pharmacy management system 113 so the pharmacist can prepare the refill according to the customer's request

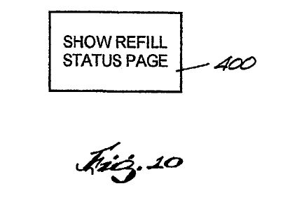

FIG. 10 schematically illustrates how the customer checks refill status using the pharmaceutical system 70. As shown at step 400, Show Refill Status Page, the customer can select a status page that displays refills ordered as described with respect to FIG. 9. In one embodiment, only the refill requests that are less than one month old are shown. The customer may be able to load the refills that are older than one month old, but ideally the customer should pickup refills in a timely manner after requesting such refills. The information displayed on the status page is similar to the information provided at step 370 as described with respect to FIG. 9. The information displayed allows the customer to check whether or not their physician authorized refills that required physician approval. If the physician authorizes the refill, the customer can pickup the refill on the date indicated on the refill status page. If the physician does not authorize the refill the customer is informed of the denial through the status page and may contact the physician regarding the denial. The pharmaceutical system 70 can automatically, or upon request by the customer, send reminders to the physician if no response is received within a set amount of time. Once the customer has finished reviewing the refill status page, the customer can return to the main page. All information regarding refills requested and later verified is sent to the respective pharmacy management system 114 so the pharmacist can prepare the refill according to the customer's request.

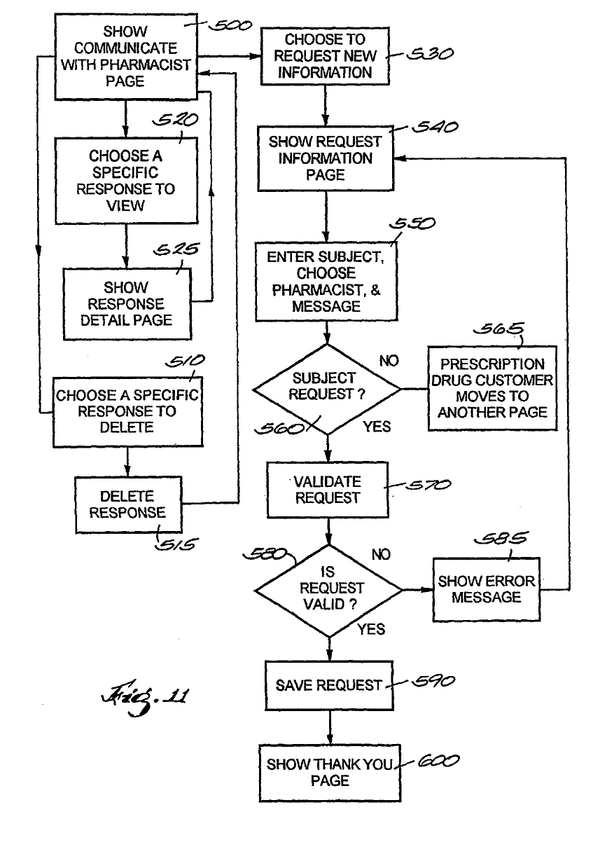

FIG. 11 schematically illustrates how the customer requests information and views responses using the pharmaceutical system 70. The embodiment of the invention illustrated in FIG. 11 primarily relates to communication of customer/pharmacy data. Generally, the customer interacts with the pharmacist at the retail pharmacy to a greater extent than he or she interacts with the other parties. However, the pharmaceutical system 70 can be configured to allow the customer to request information and view the responses with respect to other types of communication (i.e., customer/physician, customer/drug manufacturer, customer/fiscally responsible party, customer/governmental agency, etc.). As shown at step 500, Show Communicate with Pharmacist Page, the customer can request information and view responses from their pharmacist. A web page is loaded that allows the customer to request new information, view a response to past information requests, or delete old responses that are no longer needed.

As shown at step 510 and 515, the customer can delete responses. In one embodiment, the Communicate With Pharmacist Page is similar to an email system that includes a listing of all old, new, and outgoing messages. The customer may organize the responses stored in their account by eliminating old responses. Once the deletion and organization is completed, the customer may return to the Communicate With Pharmacist Page.

As shown at step 520, Choose a Specific Response to View, the customer can select a response from the pharmacist to view. The response may be a new response that has not yet been viewed or an old response that has already been viewed. After the response is selected, as shown at step 525, Show Response Detail Page, the chosen response is displayed. Once the selected response is viewed, the customer can return to the Communicate With Pharmacist Page.

As shown at step 530, Choose to Request New Information, the customer can request information from the pharmacist. This information may include information about a particular drug the customer discovered to be an alternative to his current prescription, information about a side effect the customer is experiencing, or other information. A web page is displayed at step 540, Show Request Information Page, that allows the customer to input the information they would like to request from the pharmacist. At step 550, Enter Subject, Choose Pharmacist, and Message, the customer enters a subject of the information requested, chooses the pharmacist they would like to answer their question (if a particular pharmacist is desired), and writes the message requesting information. At step 560, Submit Request?, the customer determines whether to submit the request. If the customer does not submit the request, the customer moves to another page, as shown at step 565, Customer Moves to Another Page. In a preferred embodiment, the web site reloads the main page of the site. If the customer submits the request, the request is validated, as shown in steps 570 and 580. If the request is invalid, an error message is generated, as shown at step 585. If the request is valid, the request is saved in the database server 104 at step 590, Save Request. At step 600, Show Thank You Page, the customer is informed that the request was successfully saved. Once the customer has completed viewing the confirmation page, the customer is redirected to step 500 and the account page is redisplayed. All requests for information are sent to the respective pharmacy so the pharmacist can prepare a response to the request for information.

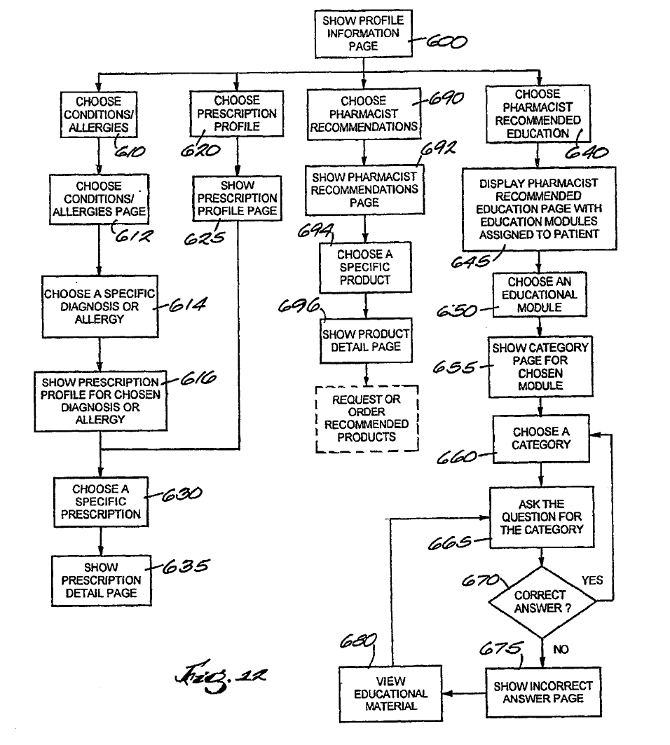

FIG. 12 schematically illustrates how the customer views his or her profile information using the pharmaceutical system 70. As shown at step 600, Show Profile Information Page, the customer can view their profile information. A web page is loaded that allows the customer to view current medical diagnoses and choose various information about their profile.

As shown at steps 610 and 612, the customer can view all conditions and allergies currently listed in their profile. In an alternative embodiment, the system may display all conditions and allergies currently listed in the system. This allows the customer to research conditions and allergies that they may have (based on symptoms they are experiencing), but have not yet been diagnosed. The customer then selects a specific diagnosis or allergy at step 614, Choose a Specific Diagnosis or Allergy. Once the specific diagnosis or allergy is selected, available treatments are displayed, as shown at step 616, Show Prescription Profile Page for Chosen Diagnosis or Allergy. The customer then selects a specific prescription at step 630, Choose a Specific Prescription, and once the customer has selected a specific prescription, a web page is loaded at step 635, Show Prescription Detail Page, that displays information including directions, warnings, and common uses for the chosen prescription. The customer may also arrive at steps 630 and 635 by other routes shown in FIG. 12.

As shown at steps 620 and 625, the customer can view all prescription listings currently in their profile. In one embodiment, only the prescriptions issued in the past one year are displayed. In an alternative embodiment, the system may display all current prescription listings in the system for the customer. This allows the customer to research prescriptions they learn about through various communication avenues, and thus determine if they would be effective in treating conditions and/or allergies they currently are experiencing. The customer is then directed to steps 630 and 635.

As shown at steps 640 and 645, the customer can view education materials recommended by the pharmacist. The pharmacist may utilize the educational materials as a method of teaching the customer how to efficiently and effectively use the drugs or treatments prescribed to them. In one embodiment, the educational modules may be utilized to satisfy the explanation requirements placed on the pharmacist by government agencies. The customer then selects a specific educational module at step 650, Choose an Educational Module, and a category page for the chosen module is displayed at step 655, Show Category Page for Chosen Module. At step 660, Choose a Category, the customer selects a category of the chosen educational module. Once a category is chosen, a question for the category is asked of the customer at step 665. The question quizzes the customer and determines whether or not the customer understands the information without viewing the educational content of the module. The customer may have already reviewed the educational content of the category at an early date, or discussed it in person with the pharmacist. At step 670, Correct Answer?, a determination is made whether or not the customer answered the question correctly. If answered correctly, the customer is directed to step 660 and another category is chosen. If answered incorrectly, the customer is informed of the incorrect response, as shown in step 675. Once the customer has completed viewing the incorrect answer page, the customer can proceed to step 680, View Educational Material. The customer then views the displayed information about the chosen category. The customer is questioned about the category again, as shown at step 665. If the customer continues to answer the question incorrectly, the customer is directed back to the educational material.

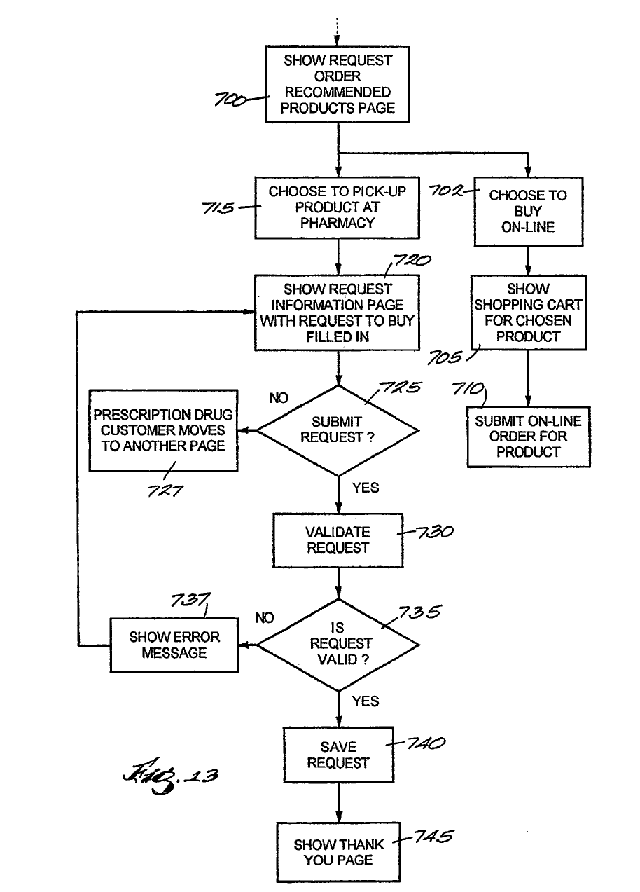

As shown at step 690, Choose Pharmacist Recommendations, the customer can view recommendations made by the pharmacist. If selected, a web page is loaded that displays the products recommended by the pharmacist for the customer, as shown at step 692. At step 694, Choose a Specific Product, the customer selects a product from the list of recommended products and product detail page is displayed, as shown at step 696 includes a description of the chosen product and benefits of using the chosen product. The customer may then request or order the selected products as described with respect to FIG. 13.

FIG. 13 schematically illustrates how the customer requests or orders recommended products using the system 70. As shown at step 702, Show Request or Order Recommended Products Page, the customer can request or order products recommended to them by the pharmacist or one of the other parties involved in the pharmaceutical system. The customer can elect to buy the product on-line or elect to buy the product at a retail location, such as a pharmacy.

If the customer elects to purchase the product on-line, the customer is directed to step 702, Choose to Buy On-line. The customer can then select the product for purchase at step 705, Show Shopping Cart for Chosen Product, by placing the product in their shopping cart in accordance with commonly known e-commerce product purchasing techniques. At step 710, Submit On-line Order for Product, the customer checks out and purchases all the products they have placed in their on-line shopping cart. If the customer purchases an item on-line, the representative information will be transferred to an appropriate facility for shipment of the product to the customer.

If the customer wants to pickup the product at the pharmacy, the customer is directed to step 715, Choose to Pickup Product at Pharmacy. At step 720, Show Request Information Page with Request to Buy Filled In, a web page is displayed that includes a request to purchase by the customer. The customer can then submit the request, as shown at step 725. If the customer determines not to submit the request, the customer is directed to another page, as shown at step 727. If a request is submitted, the request is validated at steps 730 and 735. If the request is not valid, an error message is generated, as shown at step 737. If the request is valid, the request is saved at step 740, Save Request, and the customer is informed that the request was successfully submitted at step 745, Show Thank You Page. Once the customer has completed viewing the confirmation page, the customer is redirected to step 600, as shown in FIG. 12. If the customer purchases an item for pickup at the pharmacy, that information is transferred to the pharmacy.

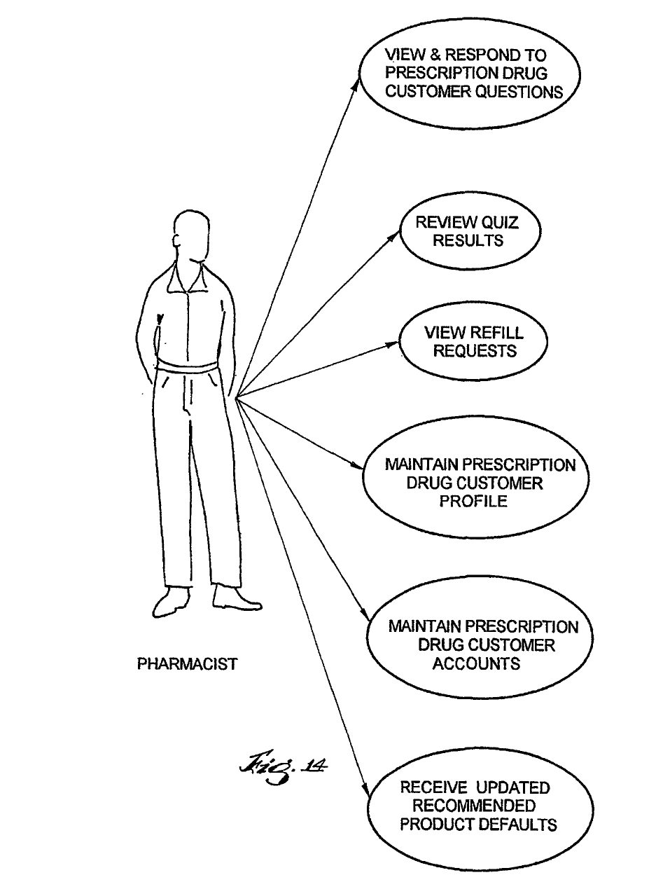

FIG. 14 schematically illustrates some of the functions the pharmacist performs utilizing the pharmacy management system 70. The pharmacist views and responds to customer questions, reviews quiz results, views refill requests, maintains customer accounts, maintains customer profiles, and receives updated recommended product defaults.

When a customer submits a question to the pharmacist, the pharmacist reviews the information requested and prepares an appropriate response. If the pharmacist believes the customer is experiencing some undesirable side effects or some other adverse reaction that requires immediate attention, they may contact the customer directly and request that they visit their physician. The pharmacist may determine that some questions that are repeatedly asked are better dealt with by providing all customers the opportunity to review answers to frequently asked questions using the web site.

The pharmacist reviews quiz results to determine if the educational content is effective in educating the customer. If numerous customers reviewing a particular educational module are getting the content questions incorrect, the pharmacist may wish to update the educational content or use other avenues of educating the customer with respect to the particular drug or treatment. The pharmacist may also review quiz results to determine if the customer has actually reviewed the material that was recommended to them.

The pharmacist views refill requests and prepare the refills for pickup according to the date entered by the customer. The pharmacy management system 114 can include a scheduler that informs the pharmacist when a particular refill request needs to be filled so the refills are always ready for pickup as indicated. If authorization by the customer's physician is required before further action is taken, the pharmacist can note that and wait for the appropriate authorization. If the authorization is not received as the time nears for pickup, the pharmacist can use the pharmaceutical system 70 to inform the physician of such required response.

The pharmacist maintains customer accounts and profiles adding new customers to the system, deleting old customers from the system, and updating any information that has changed for current customers. The pharmacist verifies all information when the customer comes to the pharmacy to pick up a refill to make sure that the customer still has the same insurance provider, physician, address, phone number, etc. The customer can update this information using the web site, but the pharmacist double checks the information before delivering the prescribed drugs or treatments. If other information changes for the customer, such as a new allergy, an adverse reaction, or a change in medical status (e.g., new disability detected), that information is input into the system.

The pharmacist receives updated recommended product defaults. Recommended products may be based on discounts the drug manufacturer is offering or may be based on other factors such as coverage of the product by the insurance provided. The pharmacist may also recommend products to customers that other customers with similar conditions or allergies used successfully. The pharmacist updates the recommended products the customer can view using the web site so the list is as up-to-date as possible.

When the pharmacist utilizes the pharmaceutical system 70, the pharmacist is relieved of some managerial duties that occupy a large amount of time, thereby freeing the pharmacist to practice more pharmacological science. The pharmacist has more time to study new and existing drugs and treatments, and the pharmaceutical system 70 increases the speed at which the pharmacist can review such information. In the end, the customer experiences better service from the pharmacist and, thereby, maintains a healthier lifestyle.

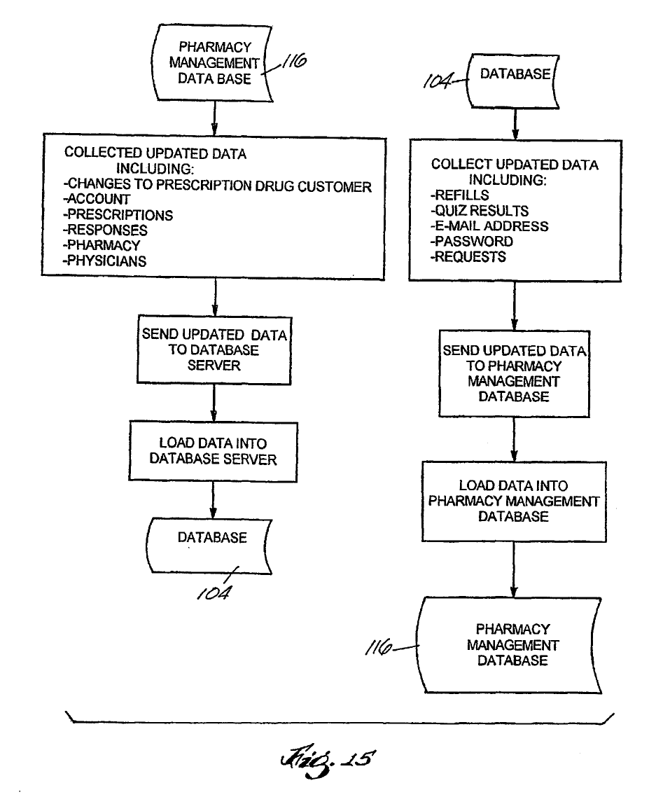

As noted, the pharmacy management system 113 communicates with the server 74 via the network 76. FIG. 15 schematically illustrates the flow of information from the pharmacy management database 116 to the database 106 and the flow of information from the database 106 to the pharmacy management database 116. As shown, the flow of information between the database 116 to the database 106 includes collecting updated data from the pharmacy management database 116 including changes to the customer's profile, account information, prescriptions, responses, pharmacy, and physician and loading the updated information into the database 106. The flow of information from the database 106 to the pharmacy management database 116 includes collected updated data from the database 106 including refills, quiz results, e-mail address, password, requests, and loading the updated information into the pharmacy management database 116. In one embodiment, the flow of information between the database 106 and the pharmacy management database 116 utilizes an XML file layout.

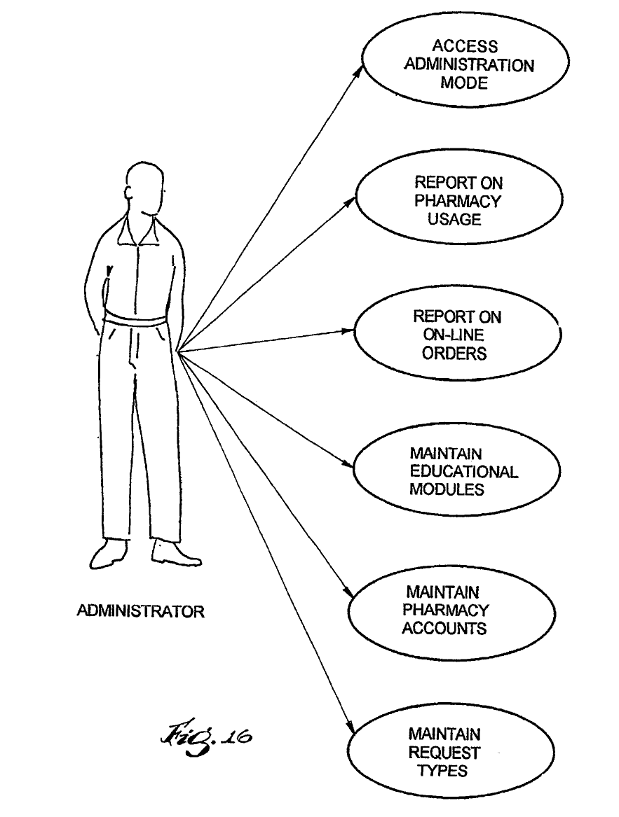

FIG. 16 schematically illustrates some of the functions the administrator can perform utilizing the administration module 110. The administrator can access the administration module 110, report on pharmacy usage, report on on-line orders, maintain educational modules, maintain pharmacy accounts, and maintain request types. As noted above, the administrator accesses the administration module 110 using the administration interface 112. Once the administrator has logged onto the administration module 110, he can interface the server and perform the representative functions illustrated in FIG. 16. The administrator can report on pharmacy usage based on number of hits on the site. The administrator can use this information in conjunction with the pharmacy in making appropriate changes to the site to increase the number of hits. The administrator may also use the counter to establish future pricing for the pharmacy.

The administrator can report on on-line orders when the customer orders a recommended product on-line. The information is transferred to an appropriate facility for processing of the order. The product is then sent to the customer at the address listed in their profile using the payment information also listed in their profile. If the product is covered by the customer's insurance, the administrator informs the customer accordingly.

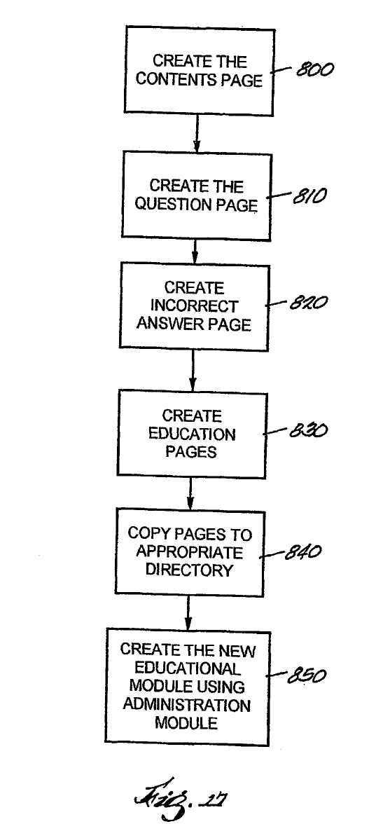

FIG. 17 schematically illustrates how an educational page for an educational module is created. The educational page is typically created outside of the administration module 110 by the drug manufacturer or the pharmacist, and then incorporated into an educational module maintained by the administrator. As shown at step 800, Create Content Page, a content page is created in HTML with appropriate links to other pages. A corresponding question page is then created at step 810, Create Question Page. The question page is directly linked from the content page. As described with respect to FIG. 12, if the customer gets the question incorrect they are informed of their incorrect response by an incorrect answer page, created at step 820, Create Incorrect Answer Page. As shown at step 830, Create Education Pages, the education pages are created in HTML (or a similar language) with links to each other. These pages are then copied to the appropriate directory in the educational content server 96 at step 840, Copy Pages to Appropriate Directory. The administrator then creates the new educational module at step 850, Create the New Educational Module, using the administration module 110.

The administrator maintains pharmacy accounts by updating any information that has changed. Similarly, the administrator makes any changes to the pharmacy specific web page if the customers are having difficulty with the web page. Changes to account information may include pricing, billing, location, contact information, pharmacists at the location, affiliation with other pharmacies, etc. The administrator also, establishes what types of request the customer can and cannot make. The requests may be limited to a list of topics that have been approved by the parties involved in the pharmaceutical system. If a particular drug manufacturer does not want to receive requests for a certain type of information, the administrator can invalidate such a request and thereby not allow the request to be processed.

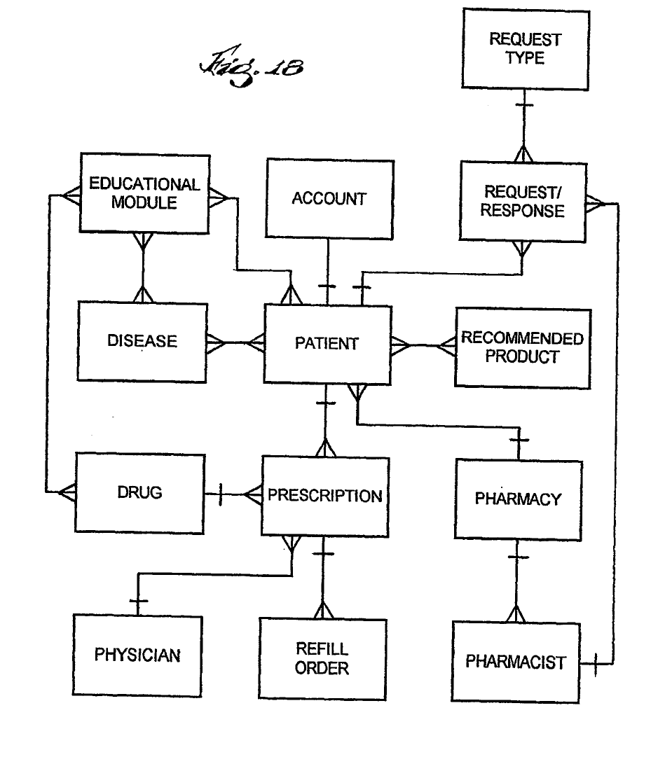

FIG. 18 schematically illustrates a data model diagram upon which one embodiment of the invention is based. The data model diagram represents the interaction between entities of the pharmaceutical system 70. Cardinality is indicated by the presence or absence of a crow's foot at the end of a relationship branch. If the terminating end of a relationship branch has a crow's foot, an instance of the originating entity can be related to one or more instances of the terminating entity. If the terminating end is a single line, an instance of the originating entity can be related to only one instance of the terminating entity. For example, the relationship between a patient and an account is drawn as a straight line indicating only one account per patient is allowed. In the case of a physician-prescription relationship, a single line at the physician's box and crow's foot at the prescription box indicates that a single physician can dispense multiple prescriptions.

As can be seen from the above, the invention provides a patient centric method and system of distributing pharmaceutical products and information. Various features of the invention are set forth in the following claims.

What is claimed is:

1. A customer-centered pharmaceutical product and information distribution system comprising:
a customer terminal coupled to a network;
a pharmacy terminal coupled to the network, the pharmacy terminal coupled to a pharmacy management system having a database;
an insurance provider terminal coupled to the network, the insurance provider terminal coupled to an information store having information regarding insurance coverage;
a server coupled to the network, the server having a site accessible by the customer terminal the pharmacy terminal, and the insurance provider terminal and a database that is synchronized with the database of the pharmacy management system.

2. The system as claimed in claim 1, further comprising a drug manufacturer terminal coupled to the network, and wherein the site is accessible by the drug manufacturer terminal.

3. The system as claimed in claim 1, further comprising a fiscally responsible party terminal coupled to the network, and wherein the site is accessible by the fiscally responsible party terminal.

4. The system as claimed in claim 1, further comprising a physician terminal coupled to the network, and wherein the site is accessible by the physician terminal.

5. The system as claimed in claim 1, further comprising a flexible benefits operator terminal coupled to the network, and wherein the site is accessible by the flexible benefits operator terminal.

6. A customer-centered pharmaceutical product and information distribution system comprising:
a customer terminal coupled to a network;
a pharmacy terminal coupled to the network, the pharmacy terminal coupled to a pharmacy management system having a database;
a third terminal selected from the group of a an insurance provider terminal, a fiscally responsible party terminal, a physician terminal, a government agency terminal, a drug manufacturer terminal, and a flexible benefits operator terminal, the third terminal coupled to the network; and
a server coupled to the network, the server having a site accessible by the customer terminal, the pharmacy terminal, and the third terminal and a database that is synchronized with the database of the pharmacy management system.

7. The system as claimed in claim 6, wherein the insurance provide terminal is coupled to an insurance store having information regarding insurance coverage.

8. A method of networking a customer with parties involved in providing information and services that can increase the customer's involvement and influence in making personalized pharmaceutical decisions, the method comprising:
providing customer/pharmacy data on a network;
providing customer/insurance company data on the network;
providing customer/pharmaceutical manufacturer data on the network; and
granting access to the network to each of a customer, a pharmacist, an insurance company, and a pharmaceutical manufacturer.

9. The method of claim 8, further comprising:
providing customer/flexible benefits account data on the network; and
granting access to the network to an operator of the flexible benefits account.

10. The method of claim 8, further comprising:
providing customer/physician data on the network; and
granting access to the network to a physician.

11. The method of claim 8, further comprising establishing a site and coupling the site to the network.

12. A method of networking a customer with a parties involved in the distribution of prescription drugs, the method comprising:
providing customer/pharmacy data on a network;
providing customer/insurance company data on the network; and
granting access to the network to the customer and the pharmacy.

13. The method as claimed in claim 12, further comprising granting access to the network to an insurance company.

14. The method as claimed in claim 12, further comprising:
providing customer/pharmaceutical manufacturer data on the network; and
granting access to the network to a pharmaceutical manufacturer.

15. The method as claimed in claim 12, further comprising:
providing customer/physician data on the network; and
granting access to the network to a physician.

16. The method as claimed in claim 12, further comprising:
providing customer/flexible benefits account data on the network; and
granting access to the network to an operator of the flexible benefits account.

17. A method of helping a customer make an informed pharmaceutical decision, the method comprising:
creating a site accessible by the customer;
providing the customer access to the site and at least two parties selected from the group of a pharmacist, a pharmaceutical manufacturer, an insurance provider, a fiscally responsible party, a government agency, and a flexible benefits operator to facilitate communication between the customer and the at least two parties and to increase the amount of useful information available to the customer.

18. A customer-centered pharmaceutical product and information distribution system based on a data model where relationships exist between multiple entities and wherein an originating entity can be related to one or more instances of a terminating entity, the data model comprising:
a patient entity relationally linked to an account entity;
a patient entity relationally linked to a prescription entity;
a patient entity relationally linked to a pharmacy entity;
a pharmacist entity relationally linked to a pharmacy entity; and
a prescription entity relationally linked to a physician entity;

19. The system as claimed in claim 18, and wherein the patient entity can have a relationship with a single account entity, and the account entity can have a relationship with a single patient entity.

20. The system as claimed in claim 18, and wherein the patient entity can have a relationship with multiple prescription entities, and the prescription entity can have a relationship with a single patient entity.

21. The system as claimed in claim 18, and wherein the patient entity can have a relationship with a single pharmacy entity, and the pharmacy entity can have a relationship with multiple patient entities.

22. The system as claimed in claim 18, and wherein the pharmacist entity can have a relationship with a single pharmacy entity, and the pharmacy entity can have a relationship with multiple pharmacist entities.

23. The system as claimed in claim 18, and wherein the prescription entity can have a relationship with a single physician entity, and the physician entity can have a relationship with multiple prescription entities.

24. The system as claimed in claim 18, the system further comprising a patient entity relationally linked to an educational module entity.

25. The system as claimed in claim 24, and wherein the patient entity can have a relationship with multiple educational module entities, and the educational module entity can have a relationship with multiple patient entities.

26. The system as claimed in claim 18, the system further comprising a patient entity relationally linked to a disease entity.

27. The system as claimed in claim 26, and wherein the patient entity can have a relationship with multiple disease entities, and the disease entity can have a relationship with multiple patient entities.

28. The system as claimed in claim 18, the system further comprising a patient entity relationally linked to a recommended product entity.

29. The system as claimed in claim 28, and wherein the patient entity can have a relationship with multiple recommended product entities, and the recommended product entity can have a relationship with multiple patient entities.

30. The system as claimed in claim 18, the system further comprising a patient entity relationally linked to a request/response entity.

31. The system as claimed in claim 30, and wherein the patient entity can have a relationship with multiple request/response entities, and the request/response entity can have a relationship with a single patient entity.

32. The system as claimed in claim 18, the system further comprising a pharmacist entity relationally linked to a request/response entity;

33. The system as claimed in claim 32, and wherein the pharmacist entity can have a relationship with multiple request/response entities, and the request/response entity can have a relationship with a single pharmacist entity.

34. The system as claimed in claim 18, the system further comprising a request/response entity relationally linked to a request type entity.

35. The system as claimed in claim 34, and wherein the request/response entity can have a relationship with a single request type entity, and the request type entity can have a relationship with multiple request/response entities.

36. The system as claimed in claim 18, the system further comprising prescription entity relationally linked to a drug entity.

37. The system as claimed in claim 36, and wherein the prescription entity can have a relationship with a single drug entity, and the drug entity can have a relationship with multiple prescription entities.

38. The system as claimed in claim 18, the system further comprising a prescription entity relationally linked to a refill order entity.

39. The system as claimed in claim 38, and wherein the prescription entity can have a relationship with multiple refill order entities, and the refill order entity can have a relationship with a single prescription entity.

40. The system as claimed in claim 18, the system further comprising a drug entity relationally linked to an educational module entity.

41. The system as claimed in claim 40, and wherein the drug entity can have a relationship with multiple educational module entities, and the educational module entity can have a relationship with multiple drug entities.

42. The system as claimed in claim 18, the system further comprising an educational module entity relationally linked to a disease entity.

43. The system as claimed in claim 42, and wherein the educational module entity can have a relationship with multiple disease entities, and the disease entity can have a relationship with multiple educational module entities.

44. A customer-centered pharmaceutical product and information distribution system based on a data model where relationships exist between multiple entities and wherein an originating entity can be related to one or more instances of a terminating entity, the data model comprising:
a patient entity relationally linked to an account entity;
a patient entity relationally linked to a prescription entity;
a patient entity relationally linked to a pharmacy entity;
a pharmacist entity relationally liked to a pharmacy entity;
a prescription entity relationally linked to a physician entity;
a patient entity relationally linked to a recommended product entity,
a patient entity relationally linked to a request/response entity;
a pharmacist entity relationally linked to a request/response entity;
a request/response entity relationally linked to a request type entity; and
a prescription entity relationally linked to a refill order entity;

45. A customer-centered pharmaceutical product and information distribution system based on a data model where relationships exist between multiple entities and wherein an originating entity can be related to one or more instances of a terminating entity, the data model comprising:
a patient entity relationally linked to an account entity;
a patient entity relationally linked to a prescription entity;
a patient entity relationally linked to a pharmacy entity;
a pharmacist entity relationally linked to a pharmacy entity;
a prescription entity relationally linked to a physician entity,
a patient entity relationally linked to an educational module entity;
a patient entity relationally linked to a disease entity;
a prescription entity relationally linked to a drug entity;
a drug entity relationally linked to an educational module entity; and
an educational module entity relationally linked to a disease entity.

46. A customer-centered pharmaceutical product and information distribution system based on a data model where relationships exists between multiple entities and wherein an originating entity can be related to one or more instances of a terminating entity, the data model comprising:
a patient entity relationally linked to an account entity;
a patient entity relationally linked to an educational module entity;
a patient entity relationally linked to a disease entity;
a patient entity relationally linked to a prescription entity;
a patient entity relationally linked to a pharmacy entity;
a patient entity relationally linked to a recommended product entity;
a patient entity relationally linked to a request/response entity;
a pharmacist entity relationally linked to a pharmacy entity;
a pharmacist entity relationally linked to a request/response entity;
a request/response entity relationally linked to a request type entity;
a prescription entity relationally linked to a drug entity;
a prescription entity relationally linked to a refill order entity;
a prescription entity relationally linked to a physician entity;
a drug entity relationally linked to an educational module entity; and
an educational module entity relationally linked to a disease entity.

47. A customer-centered pharmaceutical product and information distribution system comprising:
a customer terminal coupled to a network;
a pharmacy terminal coupled to the network;
a third terminal selected from the group of an insurance provider terminal, a fiscally responsible party terminal, a physician terminal, a government agency terminal, a drug manufacturer terminal, and a flexible benefits operator terminal, the third terminal coupled to the network;
a server coupled to the network, the server having a site; and
wherein the customer can access the site and perform at least one of the functions from the group of a maintain account function, a check refill status function, a view profile information function, a request information and view responses function, a request/order recommended products function, and a order refills function.

48. The system as claimed in claim 102, and wherein the customer accesses the site by entering a username and a password.

49. The system as claimed in claim 102, and wherein the customer can view a security policy of the site and a description of the benefits of using the site without accessing the site.

50. The system as claimed in claim 102, and wherein a hit counter is incremented when the customer accesses the site.

51. The system as claimed in claim 102, and wherein the customer can modify any of the information currently listed in their account profile including their email address and password when the customer performs the maintain account function.

52. The system as claimed in claim 102, and wherein the customer can check if their physician authorized refills that require approval by their physician before the customer can pick the refills up at the pharmacy when the customer performs the check refill status function.

53. The system as claim in claim 102, and wherein the customer can view any of the information currently listed in their account profile including at least one of the group including conditions the customer has, allergies the customer has, recommendations made to the customer by their pharmacist, prescription profiles, and educational content recommended to the customer by their pharmacist when the customer performs the view profile information function.

54. The system as claimed in claim 108, and wherein the customer can view details of a prescription that may treat the conditions and allergies the customer has.

55. The system as claimed in claim 108, and wherein the customer can view any products recommended by their pharmacist when the customer views the recommendations made to the customer by their pharmacist.

56. The system as claimed in claim 110, and wherein the customer can choose to pick up at least one of the any products from the pharmacy and then submit the request for the pick up when the customer performs the request/order recommended products function.

57. The system as claimed in claim 110, and wherein the customer can choose to buy at least one of the any products on-line and have the at least one of the any products delivered when the customer performs the request/order recommended products function.

58. The system as claimed in claim 108, and wherein the customer can correctly answer a question about the educational content recommended by their pharmacist without viewing educational material.

59. The system as claimed in claim 113, and wherein the customer views the educational material if the customer does not answer the question correctly.

60. The system as claimed in claim 108, and wherein the customer's pharmacist recommends educational content to educate the customer on prescription drugs or treatments prescribed to the customer.

61. The system as claimed in claim 102, and wherein the customer can communicate with their pharmacist via the network when the customer performs the request information and view responses function.

62. The system as claimed in claim 116, and wherein the customer can view responses from their pharmacist.

63. The system as claimed in claim 116, and wherein the customer can submit new questions to their pharmacist.

64. The system as claimed in claim 102, and wherein the customer can order refills of their prescriptions using the site when the customer performs the order refills function.

65. The system as claimed in claim 119, and wherein the customer can specify a data and time for pickup of the refill from a pharmacy.

66. The system as claimed in claim 119, and wherein the customer can submit a request to their physician for authorization of a refill request if the prescription is expired.

67. A customer-centered pharmaceutical product and information distribution system comprising:
a customer terminal coupled to a network;
a pharmacy terminal coupled to the network, the pharmacy terminal coupled to a pharmacy management system having a database;
a third terminal selected from the group of an insurance provider terminal, a fiscally responsible party terminal, a physician terminal, a government agency terminal, a drug manufacturer terminal, and a flexible benefits operator terminal, the third terminal coupled to the network;
a server coupled to the network, the server having a site; and
wherein a pharmacist operating the pharmacy terminal can access perform at least one of the functions from the group of a view and respond to prescription drub customer questions function, a review quiz results function, a view refill requests function, a maintain prescription drug customer profile function, a maintain prescription drug customer accounts function, a receive updated recommended product defaults function.
